(19) United States
(12) Patent Application Publication
(10) Pub. No.: US 2022/0234241 A1
(43) Pub. Date: Jul. 28, 2022

(54) Wood Splitter

(71) Applicants: Christopher Alan SMITH, Nelson (NZ); Wesley David OLDHAM, Nelson (NZ); Edward Phillip CUNNINGHAM, Nelson (NZ)

(72) Inventors: Christopher Alan SMITH, Nelson (NZ); Wesley David OLDHAM, Nelson (NZ); Edward Phillip CUNNINGHAM, Nelson (NZ)

(21) Appl. No.: 17/555,539

(22) Filed: Dec. 20, 2021

Related U.S. Application Data
(60) Provisional application No. 63/142,507, filed on Jan. 28, 2021.

(30) Foreign Application Priority Data
Jan. 22, 2021 (NZ) 772212

(51) Int. Cl. B27L 7/06

(52) U.S. Cl. CPC B27L 7/06

(57) ABSTRACT

A wood splitter which includes a supporting surface for receiving a section of wood to be split; the supporting surface having a cutting box on one side and a reciprocating moving head on the other side; the cutting box providing a series of spaced stationary knives through which the wood can be forced, to cut the wood, said stationary knives including a horizontal knife along the uppermost margin of the cutting box; the moving head being arranged to be reciprocable towards the cutting box so as to engage wood placed on the supporting surface and push said wood through the cutting box, and then away from the cutting box to allow a fresh piece of wood to be placed on the supporting surface; a top plate connected to the moving head by a connecting arm and movable between a first position in which the lower edge of the top plate overhangs said horizontal knife and a second position in which the top plate is raised vertically relative to the cutting box and is moved horizontally away from the supporting surface.

### TECHNICAL FIELD

The present invention relates to a machine for splitting wood for firewood i.e receiving rounds of firewood and splitting those rounds into smaller pieces, of a size which can conveniently be placed into a log burner.

### BACKGROUND ART

There are numerous different designs of log splitters in the marketplace. A majority of the splitters sold for private use or small-scale commercial use are relatively inexpensive machines which require rounds cut from logs to be manually positioned on a supporting surface and then a wedge-shaped cutter is forced into the round, to split the round in two; the cutter may move horizontally or vertically.

A large round may require an initial cut to cut it into two, and then further cuts to cut the two sections down to acceptable firewood sizes. This is relatively slow, and for large rounds of firewood, the work of lifting the round up onto the supporting surface and then handling the sections as they are cut, is heavy work.

For firewood contractors who are processing large quantities of firewood, larger scale splitters exist. Most of the larger scale splitters use stationary cutters and force the wood past the cutters rather than pushing the cutters into the wood.

One type of larger splitter is capable of forcing an entire large round of firewood through a splitting grid at a single pass. The splitting grid is an array of stationary knives shaped to completely segment the round of firewood.

These machines may be efficient, but are expensive to build because of the high pressures involved and also are expensive to operate given the amount of power that is needed to force a large round of wood through a splitting grid in a single pass.

Another type of log splitter is known as a “box wedge” splitter: in this type, a round is held in an open top “box” and is pushed through a multi-bladed stationary cutter, so that the sides of the firewood pieces produced are rectangular.

Typically, box wedge splitters are somewhat cheaper to build and operate than the cutting grid type of splitter, but it can be difficult to hold a round in the correct position for cutting, and the round may need frequent manual repositioning between cuts.

### DISCLOSURE OF INVENTION

An object of the present invention is the provision of a wood splitter which is capable of processing large rounds of wood into firewood with a minimum of handling, rapidly and safely.

The present invention provides a wood splitter which includes:

a supporting surface for receiving a section of wood to be split;

the supporting surface having a cutting box on one side and a reciprocating moving head on the other side;

the cutting box providing a series of spaced stationary knives through which wood can be forced, to cut the wood, said stationary knives including a horizontal knife along the uppermost margin of the cutting box;

the moving head being arranged to be reciprocable towards the cutting box so as to engage wood placed on the supporting surface and push said wood through the cutting box, and then away from the cutting box to allow a fresh piece of wood to be placed on the supporting surface;

a top plate connected to the moving head by a connecting arm and movable between a first position in which the lower edge of the top plate overhangs said horizontal knife and a second position in which the top plate is raised vertically relative to the cutting box and is moved horizontally away from the supporting surface.

Preferably, the top plate is biased towards the moving head by a biasing spring, which may be mounted inside, or alongside the connecting arm.

Preferably also, said lower edge of the top plate and said horizontal knife are formed with matching bevels such that as the top plate moved in use between said first and second positions, the lower edge of the top plate travels up the matching bevel of the horizontal knife so as to prevent entry of wood between the top plate and the horizontal knife.

In a preferred embodiment of the invention, the cutting box, in addition to said horizontal knife, provides a series of substantially vertical spaced stationary knives which preferably are arranged with an outer knife at each side of the cutting box and three inner knives, one of which is in the centre of the cutting box; preferably the centre knife is beveled on both sides and the remaining vertical knives each are beveled on the outer side.

In the preferred embodiment described hereinafter, the wood splitter is powered by a petrol or diesel motor which powers a hydraulic pump; the control system is hydraulically operated and the moving head is reciprocable towards/away from the cutting box by means of a hydraulic ram.

However, a wide range of different power and control systems could be used: for example, the wood splitter could be powered by an electric motor which could be battery or mains operated. The electric motor could power the hydraulic pump and hydraulic control system, or an electric motor could be used to reciprocate the moving head towards/away from the cutting box, and an electric control system used.

Another possibility would be to use an independent pump system such as a tractor power takeoff (PTO) system and tractor hydraulics.

### BRIEF DESCRIPTION OF DRAWINGS

By way of example only, a preferred embodiment of the present invention is described in detail, with reference to the accompanying drawings, in which:

FIG. 1 is a diagrammatic side view of a machine in accordance with the present invention;

FIG. 2 is a diagrammatic plan view of the machine of FIG. 1;

FIG. 2a is a plan view similar to FIG. 2, but showing an alternative design;

FIG. 3 is a side view looking into the cutting box from the exit side of the cutting box;

FIG. 4 is a view of the cutting box from above, showing the position of the knives as broken lines;

FIG. 5a is a side view of part of the machine, showing a detail of the support floor, cutting box and top plate, with the top plate at the start of a cutting operation;

FIG. 5b is a view similar to FIG. 5a but with the top plate towards the end of a cutting operation;

FIG. 6 is a part-sectioned side view showing the moving head and the connecting arm at the start of a cutting operation;

FIG. 7 is a view similar to FIG. 6, but partway through a cutting operation; and

FIG. 8 is a view similar to FIGS. 6 and 7, but towards the end of a cutting operation.

### BEST MODE FOR CARRYING OUT THE INVENTION

Referring to the drawings, a wood splitter 10 in accordance with the present invention includes a heavy duty trailer chassis 11 mounted on a pair of spaced wheels 12 and provided with a tow hitch (not visible) at the front of the chassis. It also would be possible to mount the splitter on a stationary chassis which can be positioned e.g. by a forklift.

A petrol or diesel powered motor 13 is mounted on the forward part of the chassis and powers a hydraulic pump 14. The hydraulic pump 14 is supplied with hydraulic fluid from a tank 17 mounted underneath the chassis, between the trailer wheels. Mounting the tank low down on the chassis ensures that the overall weight of the machine is kept as low as possible and the position also helps to protect the tank from accidental damage. However, the tank could be repositioned if necessary, or even positioned separate from the splitter.

The hydraulic pump 14 is connected to an hydraulic ram 14a which operates a moving head 16, to a further hydraulic ram (not shown) which operates a loading ramp 18, and to hydraulic control levers; to simplify the drawings, the hydraulic hoses, hydraulic rams, and control levers are not shown, apart from hydraulic hose 15 connected to the ram 14a.

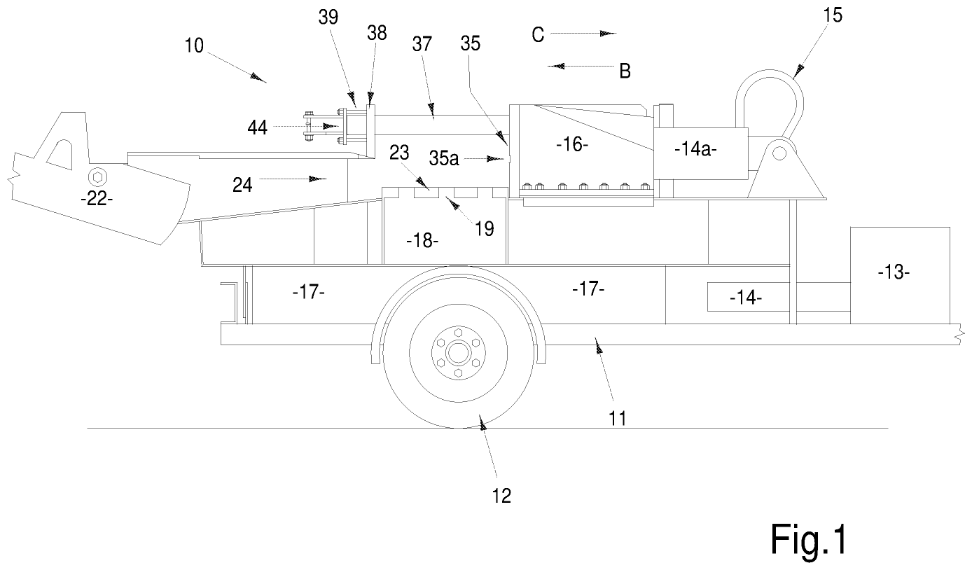

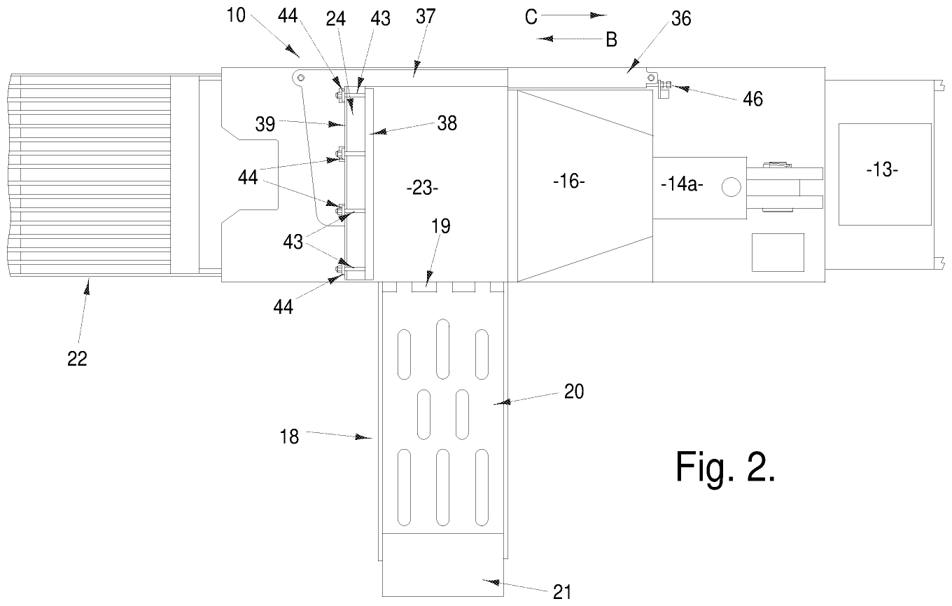

A loading ramp 18 is mounted partway along the length of the machine; only the upper portion of the loading ramp 18 is shown in FIG. 1. As shown in FIG. 2, the loading ramp consists of a long straight portion 20 and an upturned end portion 21. The loading ramp 18 is hinged along the upper edge 19 so that it can be pivoted between the lowered position shown in FIG. 2, in which the portion 20 extends at a slope over the side of the machine down to the ground, and the upturned end portion lies adjacent the ground, and a raised position in which the portion 20 is raised above the machine, to allow rounds of wood loaded onto the ramp to roll down onto the machine, as hereinafter described.

The loading ramp 18 is moved between lowered and raised positions by means of a hydraulic ram (not shown) which is manually controlled by a separate hydraulic control lever (not shown).

A discharge chute 22 is pivotally mounted at the rear of the machine, to collect and discharge the split firewood. The chute 22 can be pivoted between an extended position as partially shown in FIG. 1, and a position in which the chute is pivoted over the main body of the machine, for compact towing and storage. The chute can be fastened in either of these positions by removable fasteners (not shown). The split firewood collecting on the chute 22 is gradually pushed towards the open end of the chute and can be discharged into any suitable container (e.g. a trailer), or onto the ground. The chute 22 can be fixed in the extended position if the machine is not intended to be towed and/or stored. For some applications, the chute may be omitted altogether.

Rounds of wood loaded onto the cutting floor 23 of the machine from the loading ramp 18 are cut one at a time by moving the moving head 16 forwards in the direction of arrow B, to push each round of wood in turn through a rigidly mounted stationary cutting box 24.

The cut pieces of wood are pushed through the length of the cutting box by the pressure of subsequent pieces of cut wood, and are pushed onto the discharge chute 22.

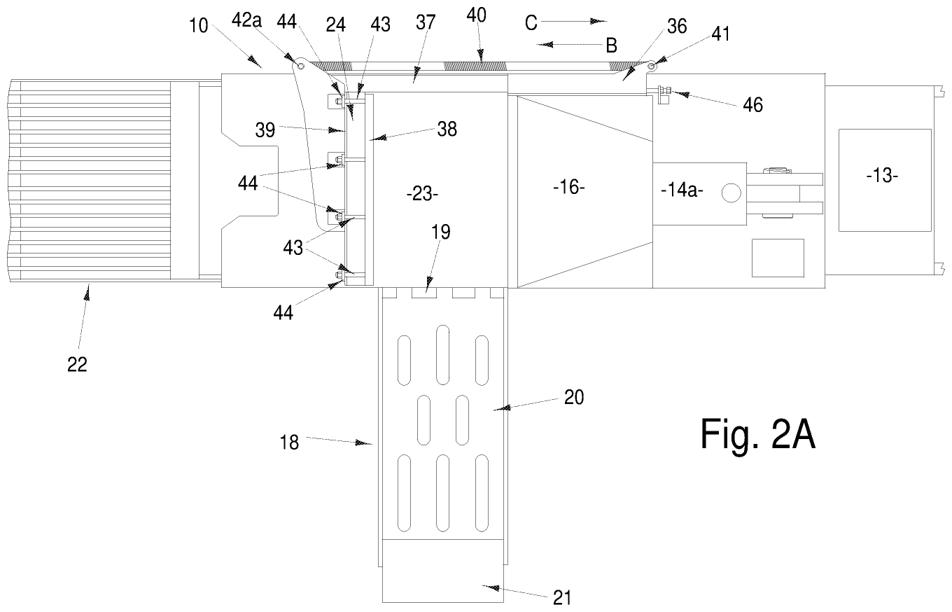

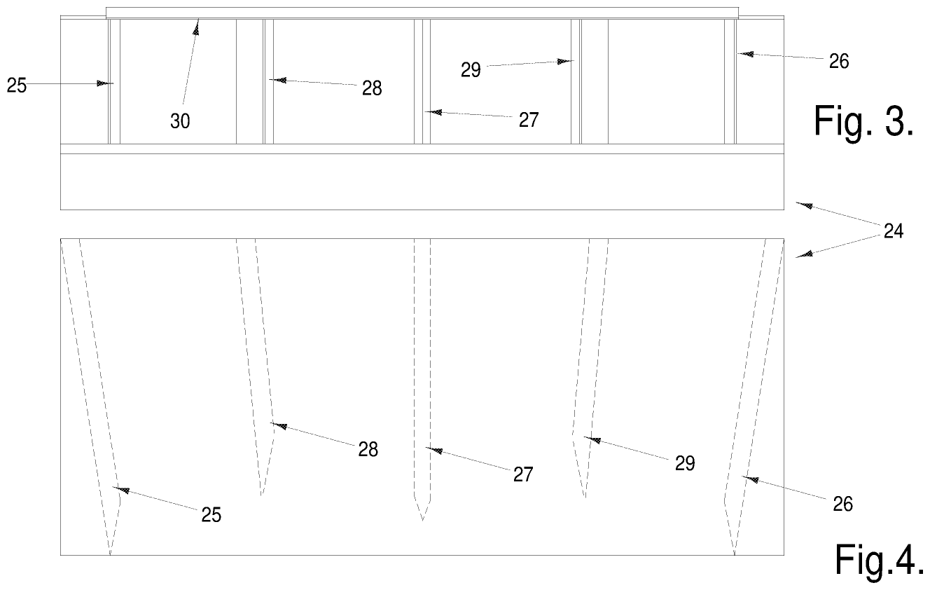

FIG. 3 shows an end on view of the cutting box 24, viewed from the exit end of the cutting box: there are two spaced outer knives 25, 26, one at each side of the cutting box, and three inner knives, arranged as a centre knife 27 and two intermediate knives 28, 29. The knives 25-29 inclusive are equidistantly spaced apart, but are not mounted level to each other: to minimise the load on the hydraulic ram (and thus on the motor 13), the outer knives 25, 26 are forward of the centre knife 27, which in turn is forward of the intermediate knives 28, 29.

A horizontal beveled knife edge 30 extends along the full length of the top of the cutting box.

The outer knives 25, 26 and the intermediate knives 28, 29 are beveled on the outer side; the centre knife 27 is beveled on both sides. The knives 25-29 are vertical, but are angled so that the spacing between adjacent knives increases from the entry into the cutting box to the exit from the cutting box, to make it easier for the wood being cut to pass through the box.

The end of the cutting box 24 remote from the moving head 16 is open, to allow the cut wood pieces to pass through the box and onto the chute 22.

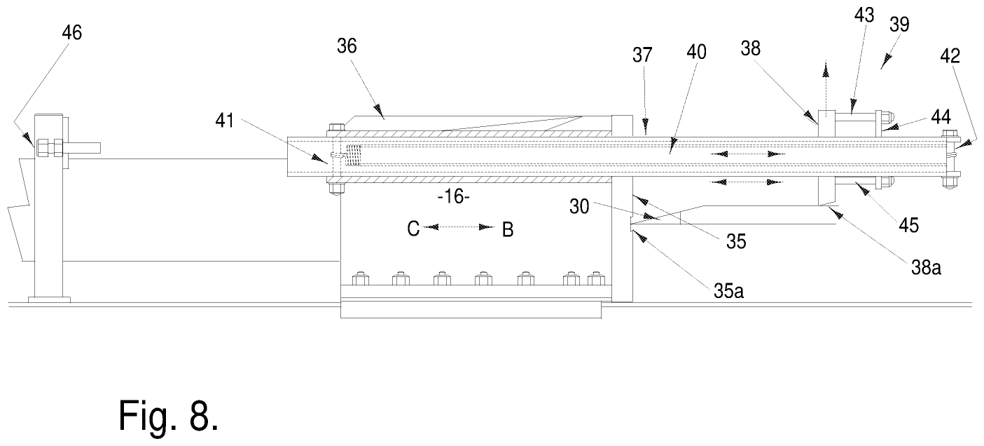

The moving head 16 is mounted on the opposite side of the cutting floor 23 to the cutting box 24, and is connected to a hydraulic ram (not visible) for reciprocating movement towards and away from the cutting box 24, as indicated by arrows B/C in FIGS. 2 and 6-8. The surface of the moving head 16 which lies closest to the cutting box 24 is a flat vertical plate 35 formed with a horizontal groove 35a which corresponds in shape and position to the position of the knife edge 30 on the top of the cutting box when the plate 35 lies adjacent the cutting box (see FIG. 8).

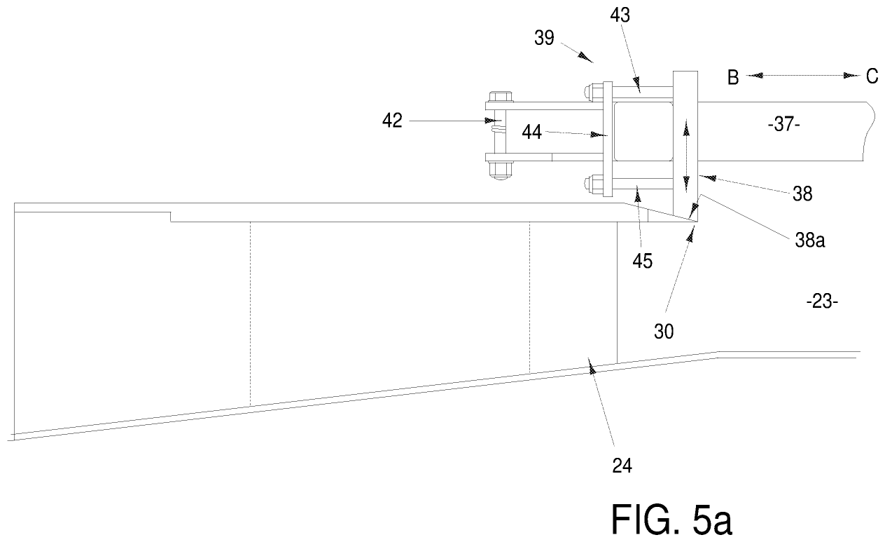

A bracket 36 is rigidly secured to one side of the moving head 16; the bracket surrounds one end of a connecting arm 37, the other end of which is secured to the supporting frame 39 of a movable top plate 38 which in one position (see FIG. 5A) overlies the horizontal knife edge 30 on the top of the cutting box.

A biasing spring 40 extends between a bolt 41 mounted across the ends of the bracket 36 and a bolt 42 mounted across the other end of the connecting arm 37. The connecting arm 37 is hollow, and the biasing spring passes down the length of the arm 37. The connecting arm 37 protects the biasing spring from debris such as timber shards, and also contains the spring in the event of the spring breaking.

Alternatively, as shown in FIG. 2a, the biasing spring 40 may be mounted along the outside of the connecting arm 37. The connecting arm 37 still offers some protection to the biasing spring from debris, and fitting the biasing spring 40 externally in this way is less expensive to construct, and makes it easier to replace a damaged or broken spring. In this alternative construction, the biasing spring 40 extends between a bolt 41 mounted across the ends of the bracket 36 and a bolt 42a mounted on the supporting frame 39 of the top plate 38.

The top plate 38 is mounted on the supporting frame 39 so as to allow the top plate 38 to rise and fall in a vertical plane: a series of spaced bolts 43 each extends between the top plate and the upper part of a bracket 44; a further series of spaced bolts 45 extends between the top plate 38 and the lower part of the corresponding bracket 44. Each of the brackets 44 is arranged to lie in two parallel horizontal slots formed through the supporting frame 39. The slots are sized to allow the brackets 44 to move vertically within the slots, to allow the top plate 38 to rise and fall in a vertical plane, as hereinafter described.

The lower edge 38a of the top plate is beveled to match the bevel on the upper surface of the knife 30, so that when the top plate rises over the knife 30, the top plate rides smoothly over the bevel of the knife 30.

An adjustable stop 46 is mounted on the machine chassis opposite said one end of the connecting arm 37. The stop 46 can be adjusted towards or away from the end of the connecting arm 37, to ensure that the connecting arm 37 stops at a position at which the top plate 38 is correctly positioned relative to the horizontal knife 30. In addition, it means that the stopping point of the connecting arm 37 can be adjusted over the life of the machine, to allow for wear on the cutting knives.

The above described machine is used as follows: the motor 13 is started to power the hydraulic pump 14 and the loading ramp 18 is lowered until the upturned portion 21 lies adjacent to the ground. A round of wood to be split is then loaded onto the ramp 18, with the longitudinal axis of the round perpendicular to the length of the ramp. The ramp is then raised so that the round of wood rolls down into the machine, to lie on the cutting floor 23, between the moving head 16 and the cutting box 24.

The operator then operates the hydraulic controls to move the moving head 16 towards the cutting box 24. The hydraulic controls are in the form of two spaced levers, both of which have to be moved to the desired position before the hydraulic system operates: this is a health and safety requirement, since it ensures that the operator must use both hands and cannot inadvertently place one hand in a dangerous zone of the machine.

Any arrangement of hydraulic controls which meets health and safety requirements (e.g. a lever plus a knob which needs to be depressed) can be substituted for the two lever design.

As the moving head 16 moves towards the cutting box 24, the round of wood lying on the cutting floor 23 is pushed into the knives 25-30. The vertical knives 25-29 cut into the face of the wood, and the horizontal knife 30 cuts horizontally through the round of wood to remove any wood which lies above the knife 30.

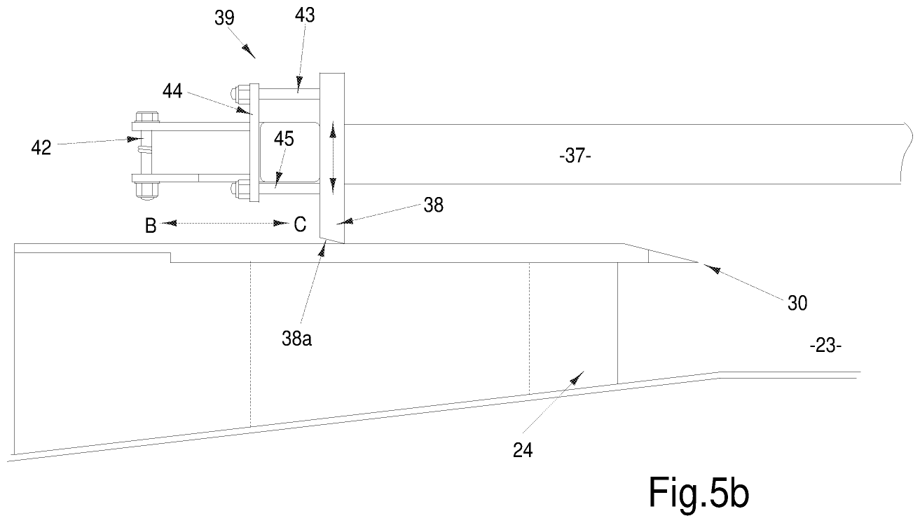

Although the moving head 16 is connected to the top plate 38 by the connecting arm 37, movement of the moving head towards the cutting box does not immediately move the top plate 38: the bracket 36 secured to one side of the moving head and surrounding the adjacent end of the connecting arm 37 is formed with a slot 50 which is dimensioned to receive the bolt 41 on which the adjacent end of the biasing spring 40 is mounted. The slot 50 allows the bracket 36 to move relative to the connecting arm 37 for the first part of the travel of the moving head 16 (FIG. 6). This means that the top plate 38 remains in place over the horizontal knife 30 until the wood pushes the top plate 38 (and thus the arm 37) upwards and forwards. From this point, the wood is securely gripped between the moving head 16 and the top plate 38.

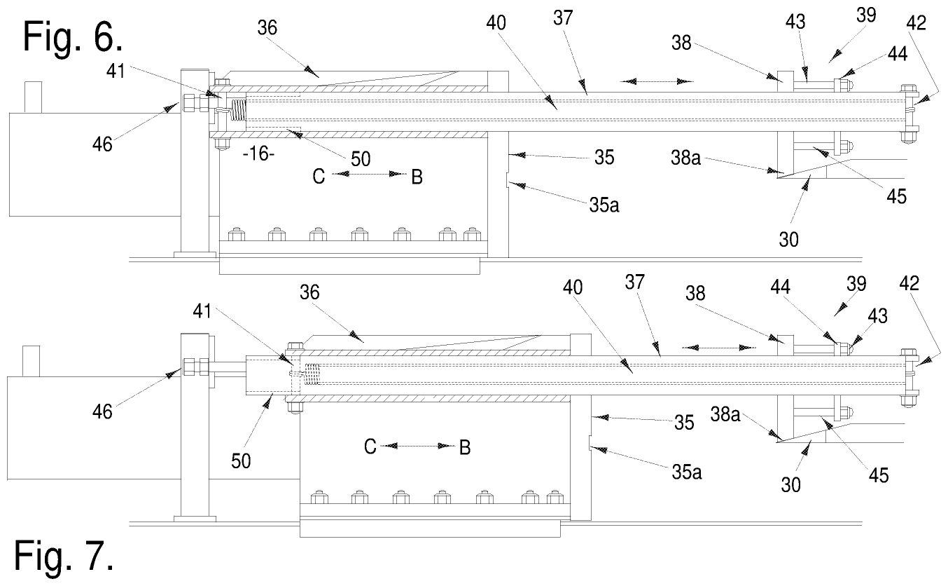

FIG. 7 shows the placement of the components at the point at which a piece of wood located on the cutting floor 23 has been contacted by the moving head 16 and has only just come into contact with top plate 38.

As shown in FIG. 8 continued movement of the moving head 16 towards the cutting box 24 not only forces the lower part of the round of wood through the cutting box but also causes the part of the round of wood which lies above the upper surface of the cutting box to rise up, aided by the bevel on the horizontal knife 30. If this upward movement is not accommodated, then it can lead to the upper part of the wood placing an upward strain on the connecting arm and additional manual handling of the wood to get the wood back into the cutting box.

The present invention overcomes this problem by allowing the top plate 38 to rise up in a vertical plane to accommodate the upward movement of the upper part of the wood: the upward force of the wood on the top plate 38 is accommodated by the upward movement of the top plate which is permitted by the movement of each of the brackets 44 in the corresponding slots formed on the supporting frame 39. Also, the top plate 38 and supporting frame 39 move horizontally with the connecting arm 37. This means that, as the lower part of a round of wood is forced through the cutting box by the moving head 16, the upper part of the round of wood, which lies above the knife 30, is cut off by the knife 30 but remains securely held between the top plate 38 and the upper part of the plate 35 which forms the front face of the moving head 16. The movement of the moving head 16 towards the cutting box 24 continues until the knife 30 lies in the groove 35 a formed across the plate 35 (FIG. 8).

It is important that the top plate 38 is able to move vertically, because this allows the upper part of the round of wood to ride over the knife 30 as it is cut horizontally, without putting undue strain on that part of the machine, and also minimises the risk of the wood jamming between the knife 30, connecting arm 37 and frame 39.

Because the lower edge 38a of the top plate 38 is beveled to match the bevel on the upper surface of the knife 30, as the top plate 38 moves vertically and horizontally relative to the knife 30, the two beveled surfaces i.e. the edge 38a of the top plate and the beveled upper edge of the knife 30, remain in contact, with the edge 38a riding smoothly over the beveled edge of the knife 30. This effectively prevents wood from coming between the top plate and the knife, and thus jamming.

Once the cut is complete and the knife 30 lies within the groove 35a, the operator reverses the hydraulic ram controlling the moving head 16, to move the moving head 16 away from the cutting box 24. During this reverse movement, the uncut portion of the wood remains firmly held between the upper part of the plate 35 and the top plate 38, because the biasing spring 40 biases the top plate 38 towards the plate 35.

Once the top plate 38 reaches its start position in which the lower edge of the top plate 38 overhangs the knife 30, the adjacent end of the returning connecting arm 37 has contacted the stop 46, so that the connecting arm 37 and the top plate 38 to which it is connected cannot move beyond the start position. In this position, any wood gripped between the top plate 38 and the moving head 16 lies over the cutting floor 23; continued reverse movement of the moving head 16 releases this wood so that it drops squarely onto the cutting floor 23 for further processing. The above described process is then repeated until the wood has been completely cut up, and then a further round is loaded using the loading ramp 18.

Low friction ultrahigh molecular weight polyethylene (UHMWPE) sheets are mounted between the underside of the moving head 16 and the underlying portion of the chassis, and similar low friction pads are provided between the connecting arm 37 and the bracket 36; the use of these pads prevents wear from the friction of steel on steel, without the need for grease or similar lubrication.

1. A wood splitter which includes:
a supporting surface for receiving a section of wood to be split;
the supporting surface having a cutting box on one side and a reciprocating moving head on the other side;
the cutting box providing a series of spaced stationary knives through which the wood can be forced, to cut the wood, said stationary knives including a horizontal knife along the uppermost margin of the cutting box;
the moving head being arranged to be reciprocable towards the cutting box so as to engage wood placed on the supporting surface and push said wood through the cutting box, and then away from the cutting box to allow a fresh piece of wood to be placed on the supporting surface;
a top plate connected to the moving head by a connecting arm and movable between a first position in which the lower edge of the top plate overhangs said horizontal knife and a second position in which the top plate is raised vertically relative to the cutting box and is moved horizontally away from the supporting surface.

2. The wood splitter as claimed in claim 1, wherein said lower edge of the top plate and said horizontal knife are formed with matching bevels such that as the top plate moved in use between said first and second positions, the lower edge of the top plate travels up the matching bevel of the horizontal knife so as to prevent entry of wood between the top plate and the horizontal knife.

3. The wood splitter as claimed in claim 1, wherein in addition to said horizontal knife, the cutting box provides a series of substantially vertical spaced stationary knives.

4. The wood splitter as claimed in claim 3, wherein said substantially vertical spaced stationary knives include an outer knife at each side of the cutting box and three inner knives, one of which is in the centre of the cutting box; the centre knife is beveled on both sides and the remaining vertical knives each are beveled on the outer side.

5. The wood splitter as claimed in claim 1, further including a discharge chute for discharging cut would, located at the side of the cutting box remote from the moving head.

6. The wood splitter as claimed in claim 5, wherein the discharge chute is pivotable between a lowered, discharge, position and a raised, storage and/or towing position.

7. The wood splitter as claimed in claim 1, wherein the top plate is biased towards the moving head by a biasing spring.

8. The wood splitter as claimed in claim 2, wherein the top plate is biased towards the moving head by a biasing spring.
